(19) United States
(12) Patent Application Publication
(10) Pub. No.: US 2017/0230612 A1
(43) Pub. Date: Aug. 10, 2017

(54) ADAPTIVE RESOLUTION ENCODING FOR STREAMING DATA

(71) Applicant: Shane Ray Thielen, Bennington, NE (US)

(72) Inventor: Shane Ray Thielen, Bennington, NE (US)

(21) Appl. No.: 15/016,229

(22) Filed: Feb. 4, 2016

(51) Int. Cl. H04N 7/01; H04L 29/06

(52) U.S. Cl. CPC H04N 7/01; H04L 65/607

(57) ABSTRACT

A file format spreads information about individual video frames over a period of time, front loading low resolution data to provide sufficient information for a low resolution playback when only a subset of the complete data file has been received. A delivery protocol corresponding to the file format delivers a stream front loaded with low resolution data. The protocol allows for adaptive resolution streaming without multi-stream encoding in real-time. Furthermore, only a single instance of the stream data needs to be encoded and stored.

### FIELD OF THE INVENTION

The present invention is directed generally toward encoding and decoding streaming data files, and more particularly toward a methodology to obviate the need for buffering during streaming a video file.

### BACKGROUND

When streaming stored data, in particular video data, the quality of the playback experience depends heavily on the bandwidth of the corresponding network connection. While broadband connections may allow smooth transmission of a data stream, connections of limited bandwidth may cause buffering where the data stream requires more bits per second than can be delivered consistently. In the context of the present application, buffering refers to the process of accumulating data from a stream until enough data is stored locally to allow for playback of at least a predetermined duration.

Compression algorithms exist to reduce the amount of data necessary. Such algorithms allow lower bandwidth data connection to deliver streaming data, but only at a fixed resolution. Streaming protocols also exist, such as adaptive bitrate streaming, that modify the resolution of the stream by continuously monitoring the available bandwidth and processing power and requesting appropriately encoded streams. Such protocols rely on continuous two-way communication and real time signal encoding at multiple bitrates.

Existing solutions are processor intensive both for monitoring the state of a data connection and for real-time encoding. Consequently, it would be advantageous if an apparatus existed that is suitable for adaptive resolution delivery of a data stream without intensive real-time encoding.

### SUMMARY

Accordingly, the present invention is directed to a novel method and apparatus for adaptive resolution delivery of a data stream without intensive real-time encoding.

In one embodiment of the present invention, a file format spreads information about individual video frames over a portion of the data file, front loading low resolution data to provide sufficient information for a low resolution playback when only a subset of the complete data file has been received.

In another embodiment of the present invention, a delivery protocol delivers a stream front loaded with low resolution data. The protocol allows for adaptive resolution streaming without multi-stream encoding in real-time. Furthermore, only a single instance of the stream data needs to be encoded and stored.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous advantages of the present invention may be better understood by those skilled in the art by reference to the accompanying figures in which:

FIG. 1 shows a computer system suitable for implementing embodiments of the present invention;

FIG. 2 shows a block diagram representation of a single video frame, highlighting a low resolution subset;

FIG. 3 shows a block diagram representation of a single video frame, highlighting a medium resolution subset;

FIG. 4 shows a block diagram representation of a single video frame, highlighting an overlay of a low resolution subset and a medium resolution subset;

FIG. 5 shows a block diagram representation of a single video frame, highlighting a remainder subset corresponding to the remaining data separate from low and medium resolution subsets;

FIG. 6 shows a block diagram representation of a single video frame, highlighting an overlay of all subsets to form a complete frame;

FIG. 7 shows a block diagram representation of a first data block comprising three video frames, highlighting low resolution subsets of each;

FIG. 8 shows a block diagram representation of a second data block comprising three video frames, highlighting low resolution subsets of two video frames and a medium resolution subset of one video frame;

FIG. 9 shows a block diagram representation of a third data block comprising three video frames, highlighting a low resolution subset of one video frame, a medium resolution subset of a second video frame and a remainder subset of third video frame;

FIG. 10 shows a block diagram representation of three data blocks comprising six video frames, showing complete or partial overlays of two video frames;

FIG. 11 shows a block diagram representation of a data file highlighting the distribution of data over the entire data stream;

FIG. 12 shows a flowchart for a method of encoding a data file according to at least one embodiment of the present invention;

FIG. 13 shows a flowchart for a method of decoding a data file according to at least one embodiment of the present invention;

### DETAILED DESCRIPTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

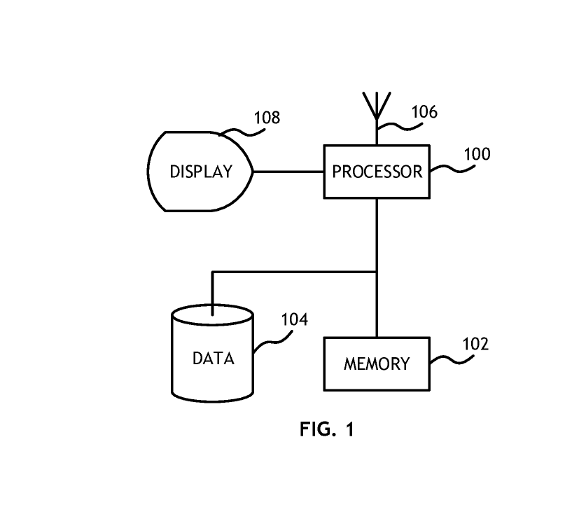

Referring to FIG. 1, a computer system suitable for implementing embodiments of the present invention is shown. In at least one embodiment of the present invention, a computer system comprises a processor 100, memory 102 connected to the processor 100 for storing processor executable code and a data storage medium 104. In one embodiment, the processor 100 receives and processes a streaming data file encoded for adaptive resolution as more fully described herein, producing a data structure applied to storage elements in the memory 102 or data storage medium 104 that may be read contiguously regardless of the data connection bandwidth. In another embodiment of the present invention, the processor 100 processes a substantially linear data file and produces a data structure comprising elements differentiated according to resolution such that lower resolution elements are front loaded to provide a complete version of the linear data file when only a subset of the complete file has been streamed. The data structure may be applied to memory elements in the memory 102 or data storage medium 104.

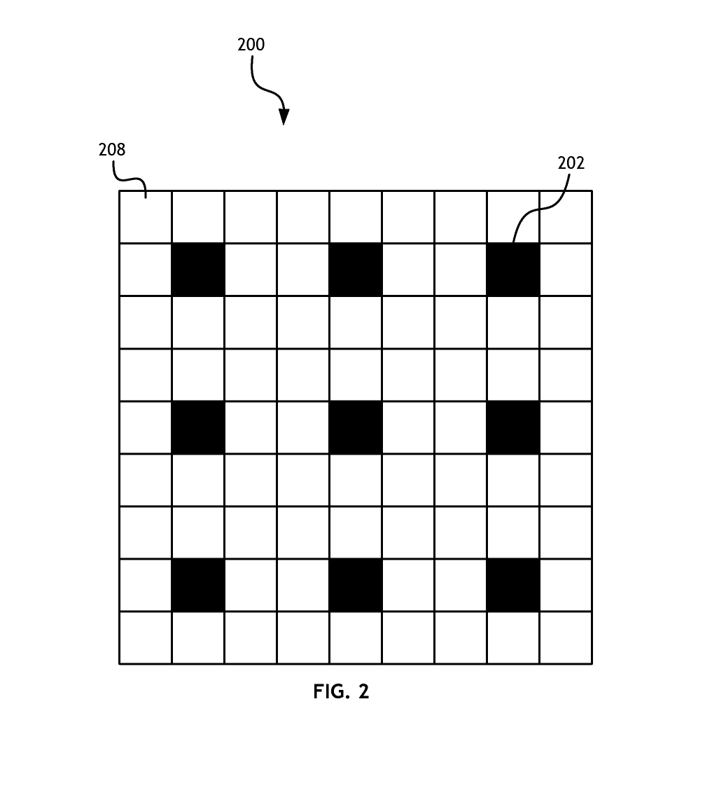

Referring to FIG. 2, a block diagram representation of a single video frame 200, highlighting a low resolution subset is shown. In one embodiment, a subset of encoded pixels 202 may be used by a decoding algorithm to produce a low resolution version of the complete image by interpolating intervening, unencoded pixels 208. For example, a lower resolution version of a data packet may only have 9 pixels per frame, and can easily be delivered by the bad data connection. Each of the 9 pixels may take the place of a block of pixels from the higher resolution version.

While FIG. 2 shows encoded pixels 202 in a particular pattern, encoded pixels 202 may be selected according to the encoding algorithm to provide sufficient data for the most accurate interpolation of unencoded pixels 208. Alternatively, encoded pixels 202 may be selected stochastically.

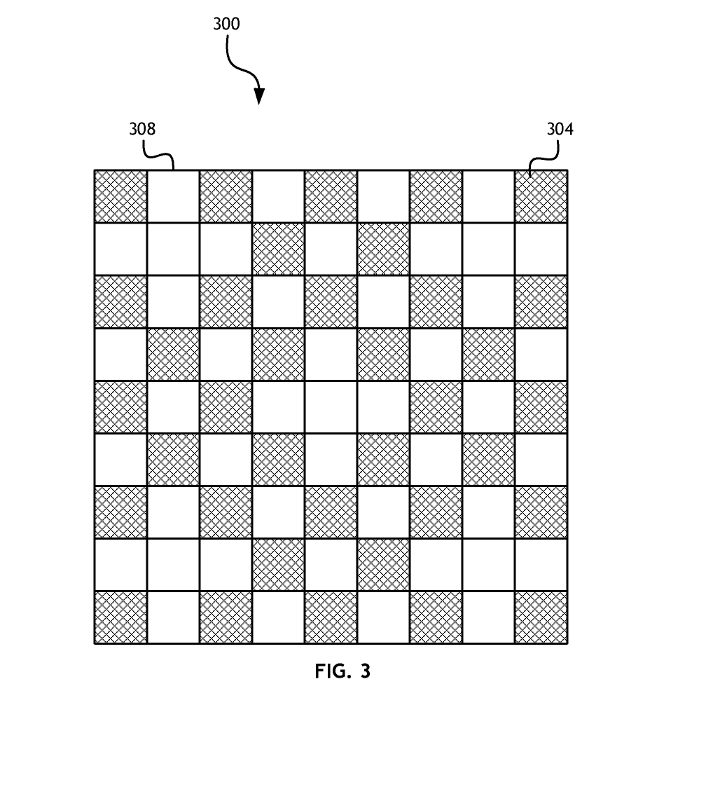

Referring to FIG. 3, a block diagram representation of a single video frame 300, highlighting a medium resolution subset is shown. In one embodiment, a subset of encoded pixels 304 may be used by a decoding algorithm, potentially in conjunction with a low resolution version, to produce a medium resolution version of the complete image by interpolating intervening, unencoded pixels 308. For example, a medium resolution version of a data packet may have 36 pixels per frame, and can be delivered by a poor quality broadband data connection.

While FIG. 3 shows encoded pixels 304 in a particular pattern, encoded pixels 304 may be selected according to the encoding algorithm to provide sufficient data for the most accurate interpolation of unencoded pixels 308. Alternatively, encoded pixels 304 may be selected stochastically.

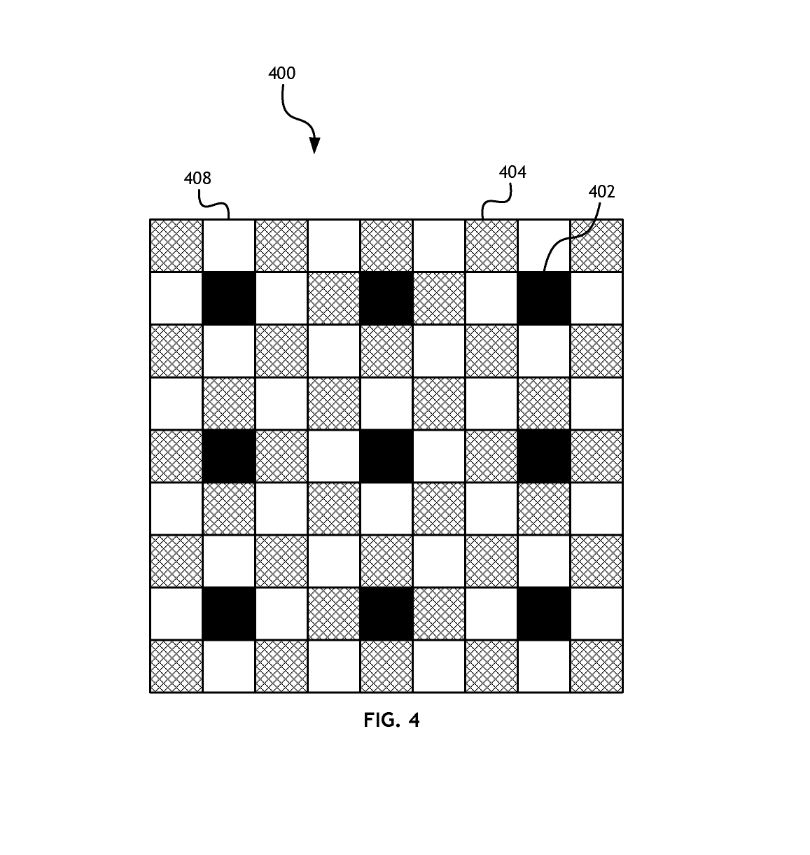

Referring to FIG. 4, a block diagram representation of a single video frame 400, highlighting an overlay of a low resolution subset and a medium resolution subset is shown. In one embodiment, where a decoding algorithm receives a low resolution subset of encoded pixels 402 and a medium resolution subset of encoded pixels 404 for a particular frame in a video stream, the low resolution subset of encoded pixels 402 and the medium resolution subset of encoded pixels 404 are combined to produce a higher resolution version of the video frame 400. Remaining unencoded pixels 408 are filled in based on available data.

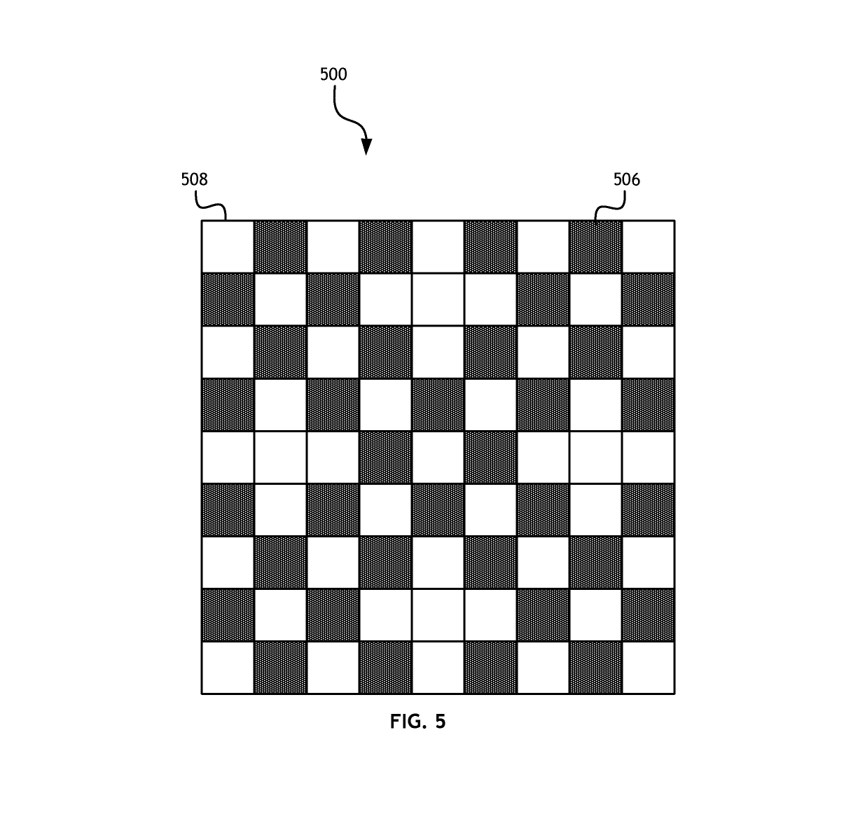

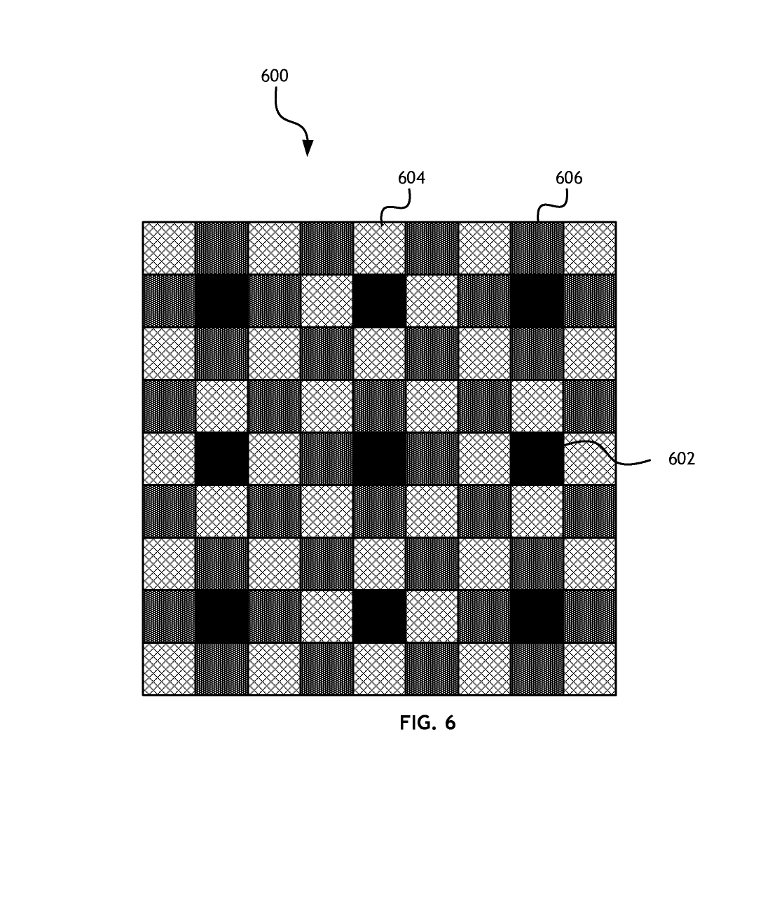

Referring to FIG. 5, a block diagram representation of a single video frame 500, highlighting a remainder subset corresponding to the remaining data separate from low and medium resolution subsets is shown. In one embodiment, the remainder subset of encoded pixels 506 may fill in all of the gaps in a single frame comprised of a low resolution subset combined with a medium resolution subset. Referring to FIG. 6, a block diagram representation of a single video frame 600, highlighting an overlay of all subsets to form a complete frame is shown. Where a low resolution subset of encoded pixels 602, a medium resolution subset of encoded pixels 604, and a remainder subset of encoded pixels 606 for a particular video frame 600 are combined, the resulting video frame 600 is complete and no interpolation is necessary apart from any additional encoded that may have been applied prior to frame parsing.

While FIGS. 2, 3, 4, 5, and 6 illustrate a low resolution pixel subset comprising 9 pixels in a regular pattern, a medium resolution pixel subset comprising 36 pixels in a semi-regular pattern, and a remainder pixel subset comprising 36 pixels in a semi-regular pattern defined by the absence of data in the other two subsets, such illustration is solely for the purpose of clearly describing the inventive concepts disclosed here. In actual implementation a single video frame may comprise millions of pixels. Various subsets of pixels may be defined by a percentage of the whole; for example, a low resolution subset may comprise approximately 10 percent of all available pixels for a particular frame, a medium resolution subset may comprise approximately 30 percent so that a combined frame would include 40 percent of a complete image, with the remaining pixels comprising the remainder subset. Alternatively, a frame may be divided into more than three subsets; for example, a first low resolution subset may comprise approximately 10 percent of all available pixels, a second medium resolution subset may comprise approximately 20 percent of all available pixels, a third high resolution subset may comprise approximately 30 percent of all available pixels, and a fourth remainder subset may comprise the remaining 40 percent.

Furthermore, even though the embodiments illustrated show regular or semi-regular pixel positioning, in alternative embodiments pixels for particular subsets may be chosen by many alternative means provided the lowest resolution version contains sufficient information to reproduce a low resolution version of the complete video frame. In some embodiments, pixels may be selected stochastically or semi-stochastically with some minimum and maximum number of pixels in particular sections of the frame. In some embodiments, pixels may be selected by analyzing each frame to identify characteristic pixels to accurately represent all surrounding pixels and thereby accentuate later interpolation if necessary.

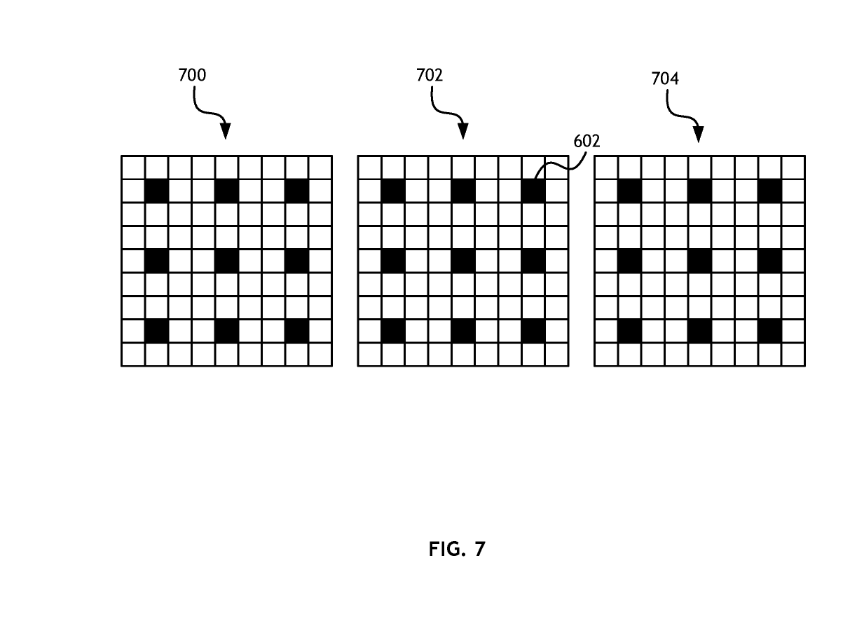

Referring to FIG. 7, a block diagram representation of a first data block comprising three video frames 700, 702, 704, highlighting low resolution subsets of each is shown. In one embodiment, an encoding algorithm may produce a first data block comprising only information about low resolution subsets of encoded pixels 602 for a first set of video frames 700, 702, 704.

While FIG. 7 illustrates low resolution subsets of three video frames 700, 702, 704 comprising identical pixel locations taken from each video frame 700, 702, 704, in some embodiments, pixel selection may differ across individual video frames 700, 702, 704. Encoded pixels 602 for a low resolution subset may be selected according to various criteria and such criteria may dictate different pixel locations in each individual video frame 700, 702, 704; for example, encoded pixels 602 may be selected to be representative of surrounding pixels for later interpolation. Alternatively, different encoded pixels 602 may be deliberately selected across video frames 700, 702, 704 so that interpolation can be performed across video frames 700, 702, 704 as well as within a single video frame 700, 702, 704. For example, as illustrated in FIG. 7, each encoded pixel 602 is centered in a block of 9 pixels, the other 8 being unencoded. An encoding algorithm may alter the encoded pixel 602 in each block of 9 pixels in subsequent video frames 700, 702, 704 such that all pixel locations would be represented in 9 consecutive video frames 700, 702, 704. A decoding algorithm may utilize low resolution information in later video frames 700, 702, 704 to interpolate unencoded pixels in a particular low resolution video frame 700, 702, 704. Such embodiment may interfere with MPEG-2 type compression if used in conjunction with embodiments of the present invention.

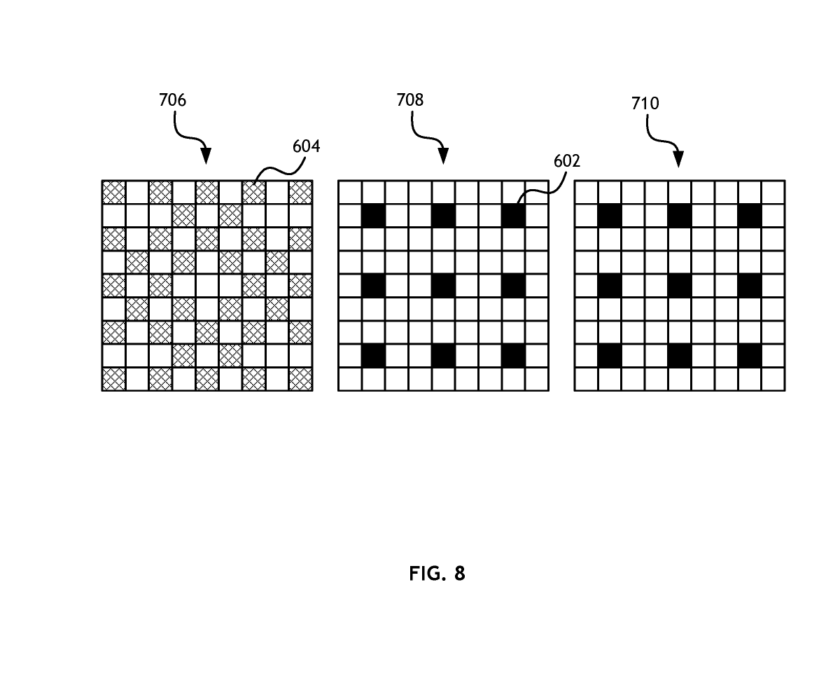

Referring to FIG. 8, a block diagram representation of a second data block comprising three video frames 706, 708, 710, highlighting low resolution subsets of two video frames 708, 710 and a medium resolution subset of one video frame 706 is shown. In one embodiment, the encoding algorithm may produce a second data block comprising information about low resolution subsets of encoded pixels 602 for a second set of video frames 708, 710 and a medium resolution subset of encoded pixels 604 for a video frame 706 corresponding to a first video frame 700 in the first data block as shown in FIG. 7.

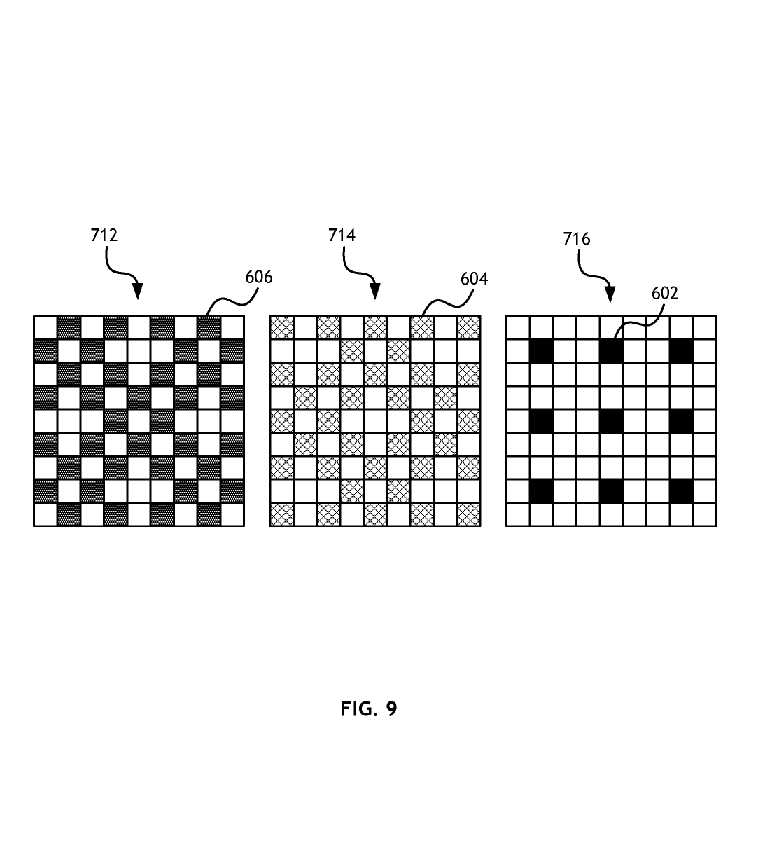

Referring to FIG. 9, a block diagram representation of a third data block comprising three video frames 712, 714, 716, highlighting a low resolution subset of a first video frame 716, a medium resolution subset of a second video frame 714 and a remainder subset of a third video frame 712 is shown. In one embodiment, the encoding algorithm may produce a third data block comprising information about a low resolution subset of encoded pixels 602 for a video frame 716, a medium resolution subset of encoded pixels 604 for a video frame 714 corresponding to a second video frame 702 in the first set of video frames 700, 702, 704 in the first data block as shown in FIG. 7, and a remainder resolution subset of encoded pixels 606 for a video frame 712 corresponding to the first video frame 700 in the first data block as shown in FIG. 7.

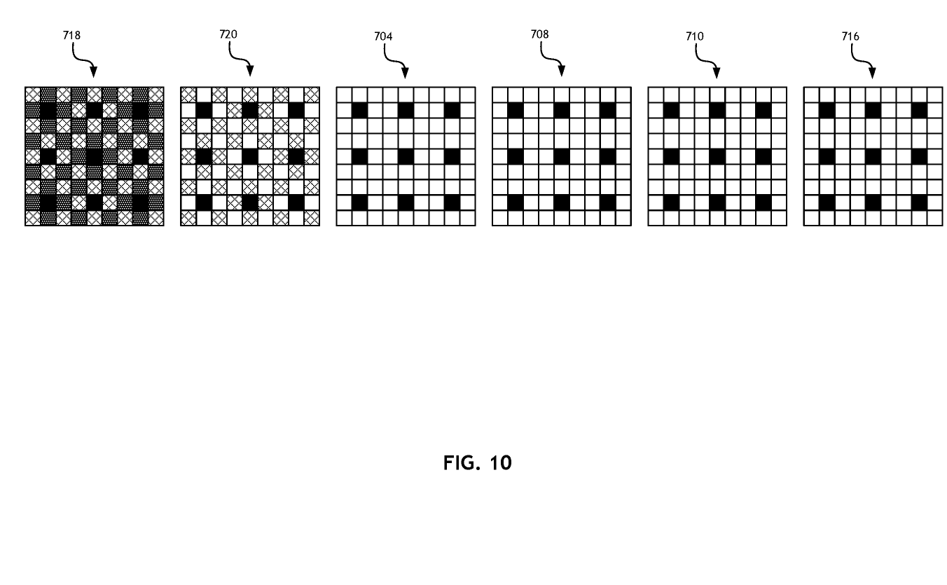

Referring to FIG. 10, a block diagram representation of three data blocks as shown in FIGS. 7, 8, 9 comprising six video frames, showing complete or partial overlays of two video frames is shown. in one embodiment, after three data blocks, a receiving computer has complete information for a first frame 718, a little more than half the complete information for a second frame 720, and some minimum amount of information for four additional video frames 704, 708, 710, 716. If the bandwidth of a streaming connection falters, no buffering is necessary; the receiving computer has sufficient data to switch to a lower resolution version of the stream without re-negotiating a connection to the server for a lower resolution version of the file and synching the stream to the previous time code.

A person skilled in the art will appreciate that the descriptions herein are overly simplified in the interest of conveying the inventive concepts. In actual implementation, each video frame 704, 708, 710, 716, 718, 720 may comprise millions of pixels. Furthermore, individual data packets are described for clarity. In actual implementation, video frame subsets may be interleaved in a continuous stream provided the stream is organized to provide sufficient data for a complete, low resolution video early, and progressively more detailed data as the stream progresses, but also provided complete data over a sufficiently robust connection as the stream is received. In some embodiments, a connection at some minimum bitrate allows transfer and decoding of the stream to produce a full resolution of a video frame in the time it takes a previous frame to play.

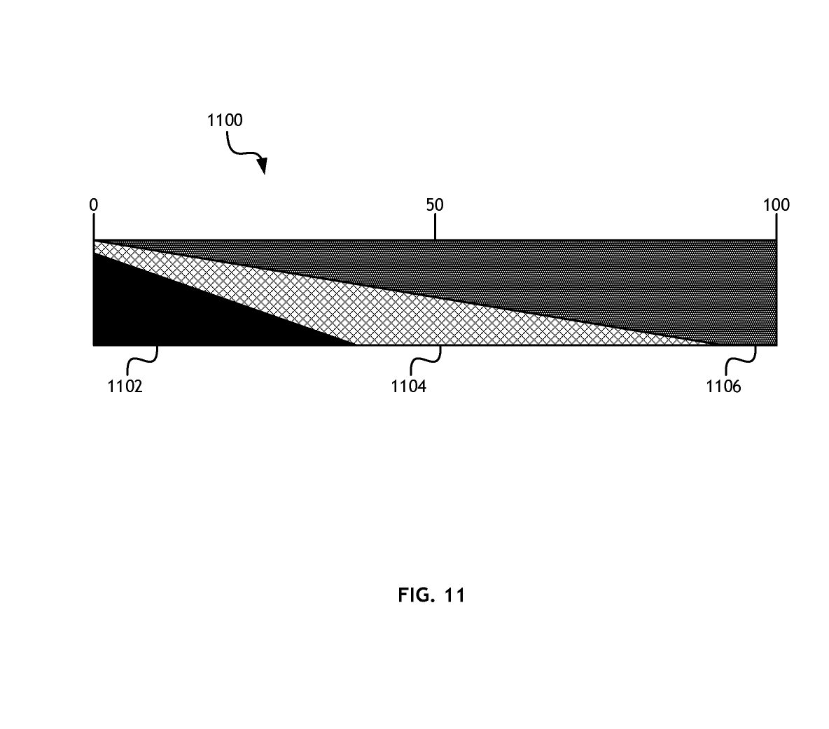

Referring to FIG. 11, a block diagram representation of a data file 1100 highlighting the distribution of data over the entire data stream is shown. The data file 1100 is parsed such that individual frames are separated into pixel subsets such that multiple pixel subsets for an individual frame may be combined to form the entire frame when all pixel subsets are available; alternatively, when less than all of the pixel subsets for a frame are available, the missing pixel data may be interpolated from the available data to form a lower resolution version of the entire frame. In one embodiment, where each frame of the data file 1100 is parsed into three pixel subsets such as a low resolution subset 1102, a medium resolution subset 1104 and a remainder subset 1106; the subsets 1102, 1104, 1106 are distributed in the data file 1100 such that early portions of the data file 1100 are more heavily weighted toward the low resolution subset 1102, with the entire low resolution subset contained in some early portion of the data file 1100 such as the first half and some portion of the end of the data file comprising only the remainder subset 1106.

The distribution of subsets 1102, 1104, 1106 is such that, given a certain minimum bitrate data connection, the data file 1100 is streamed at a rate at least equal to the playback speed of the data file 1100. That is, the remainder subset 1106 is distributed so that at least the frames necessary for a full resolution playback are available with minimal pre-playback caching. A data connection with a bitrate less than the certain minimum would still provide a playback experience without buffering by reconstructing each frame with only the low resolution subset 1102 or a combination of the low resolution subset 1102 and medium resolution subset 1104, and interpolating any missing data.

While exemplary embodiments described herein show three pixel subsets 1103, 1104, 1106, any number of subsets may be used provided the data file 1100 is weighted to provide sufficient data to construct a low resolution version of each frame within some early portion of the data file 1100 such as the first half of the data file 1100. a greater number of pixel subsets 1102, 1104, 1106 would allow for increased granularity of adaptive resolution at the expense of increased processing during playback.

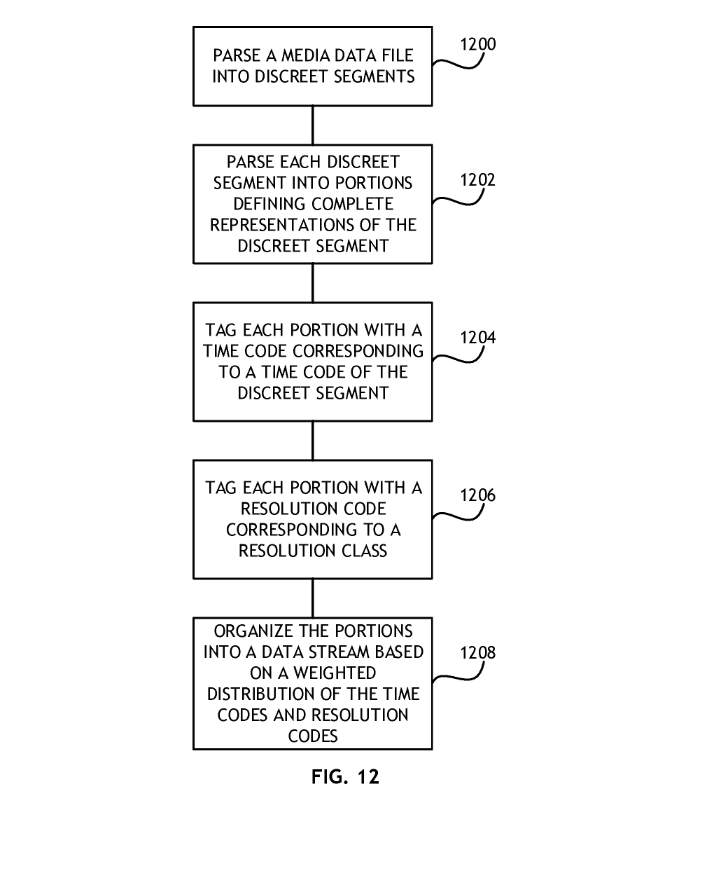

Referring to FIG. 12, a flowchart for a method of encoding a data file according to at least one embodiment of the present invention is shown. In one embodiment, a computer processor parses 1200 a video data file into discreet segments, each discreet segment comprising a single video frame or small set of video frames. Each discreet segment is then parsed 1202 into pixel subsets, each pixel subset providing sufficient information to interpolate missing information and provide a complete representation of the discreet segment, though at a lower resolution than the completed discreet segment. Each pixel subset of each discreet segment is tagged 1204 with a time code corresponding to a time code of the discreet segment; furthermore, each pixel subset is tagged 1206 with a resolution code correlating pixel subsets across discreet segments. The computer processor then organizes 1208 the pixel subsets into a data file based on a weighted distribution of the time codes and resolution codes such that all of pixel subsets for each discreet segment are placed in order of time code, and one correlated pixel subset is weighted heavily in the beginning of the data file.

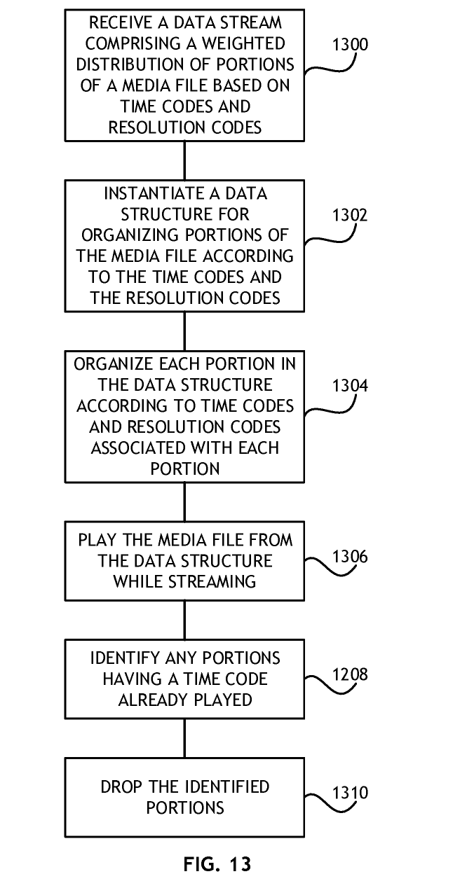

Referring to FIG. 13, a flowchart for a method of decoding a data file according to at least one embodiment of the present invention is shown. In one embodiment, a computer processor receives 1300 a data stream comprising a weighted distribution of video frame pixel subsets correlated by resolution codes and time codes. The computer processor instantiates 1302 a data structure for processing the data stream into a version suitable for playback. The data stream is then parsed into discreet portions and pixel subsets, and organized 1304 into the data structure according to time codes and resolution codes. While the stream is being received 1300 and organized 1304, the computer processor plays 1306 the video from the data structure. While playing, the processor identifies 1308 any pixel subsets received from the data stream having a time code prior to the current playback time; those pixel subsets may then be dropped 1310. Alternatively, such pixel subsets may be incorporated into the data structure in anticipation of the user potentially rewinding the video playback, wherein the video may be played back with a higher resolution than was available during the initial playback.

In some embodiments, a user may select a particular playback resolution. The computer processor may then instantiate 1302 a data structure without organizational elements for a particular correlated set of pixel subsets. Each pixel subset in that correlated set of pixel subsets may then be dropped 1310. Alternatively, the transmitting computer processor may preemptively drop all pixel subsets in the correlated set of pixel subsets so that they are not transmitted, thereby saving bandwidth.

It is believed that the present invention and many of its attendant advantages will be understood by the foregoing description of embodiments of the present invention, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A computer apparatus for encoding a video data file, comprising:
a processor;
memory connected to the processor;
a data storage medium connected to the processor; and
processor executable code stored in the memory, configured to instruct the processor to:
parse the video data file into a plurality of discreet segments, each of the plurality of discreet segments corresponding to a time code;
parse each discreet segment into a plurality of pixel subsets, the plurality of pixel subsets comprising at least a low resolution subset and a remainder subset;
tag each pixel subset with the time code corresponding to the discreet segment such pixel subset was parsed from, and a resolution code, the resolution code correlating classes of pixel subsets among each of the plurality of discreet segments;
organized the tagged pixel subsets into a data file according to time codes and resolution codes such that a first half of the data file includes a greater number of pixel subsets from the low resolution subset than the remainder subset.

2. The apparatus of claim 1, wherein parsing each discreet segment into a plurality of pixel subsets comprises selecting a representative set of pixels from the corresponding discreet segment, the representative set of pixels suitable for interpolating non-selected pixels in the corresponding discreet segment.

3. The apparatus of claim 1, wherein parsing each discreet segment into a plurality of pixel subsets comprises selecting a plurality of pixel locations, the plurality of pixel locations being consistent across the plurality of discreet segments.

4. The apparatus of claim 1, wherein parsing each discreet segment into a plurality of pixel subsets comprises:
defining a plurality of blocks, each comprising a cluster of pixel locations correlated across discreet segments;
selecting a first pixel location within each cluster of pixel locations in the low resolution subset associated with a first discreet segment; and
selecting a second pixel location within each cluster of pixel locations in the low resolution subset associated with a second discreet segment.

5. The apparatus of claim 1, wherein organizing the tagged pixel subsets into a data file comprises:
creating a first data block comprising only a plurality of pixel subsets from the low resolution subset; and
creating a second data block comprising only a plurality of pixel subsets from the remainder subset.

6. The apparatus of claim 1, wherein the plurality of pixel subsets further comprises a medium resolution subset.

7. The apparatus of claim 1, wherein organizing the tagged pixel subsets into a data file comprises placing all pixel subsets associated with the low resolution subset within a first half of the data file.

8. The apparatus of claim 1, wherein each of the plurality of pixel subsets associated with the low resolution subset comprise substantially 10 percent of a complete discreet segment.

9. The apparatus of claim 1, wherein each of the plurality of pixel subsets associated with the low resolution subset comprise pixels identified as representative of surrounding pixels in a complete discreet segment.

10. A computer apparatus for decoding a video data file, comprising:
a processor;
memory connected to the processor;
a data storage medium connected to the processor; and
processor executable code stored in the memory, configured to instruct the processor to:
receive a streaming video data file comprising a weighted distribution of pixel subsets, each pixel subset corresponding to a portion of a video frame;
instantiate a playback data structure comprising organizational elements for organizing pixel subsets according to time codes and resolution codes;
continuously identify a time code and a resolution code associated with a received pixel subset;
organize the received pixel subset into an organizational element of the playback data structure according to the time code and resolution code associated with the received pixel subset;
play the streaming video data file from the playback data structure while the video data file is streaming; and
interpolate video frame data associated with a time code where less than all pixel subsets associated with that time code have been received.

11. The apparatus of claim 10, wherein the processor executable code further configures the processor to identify an anachronistic pixel subset received from the streaming video file based on a time code associated with the anachronistic pixel subset as compared to a current playback time.

12. The apparatus of claim 11, wherein the processor executable code further configures the processor to delete the anachronistic pixel subset.

13. The apparatus of claim 10, wherein interpolating video frame data comprises averaging two or more values in a pixel subset to derive a value for a video frame pixel not defined in the pixel subset.

14. The apparatus of claim 10, wherein interpolating video frame data comprises averaging two or more values in two or more pixel subsets associated with different time codes.

15. The apparatus of claim 10, wherein the processor executable code further configures the processor to combine two pixel subsets having the same time code to produce a composite video frame.

16. A video data file encoded for adaptive resolution and stored in a tangible medium, comprising:
a plurality of pixel subsets, each of the plurality of pixel subsets associated with a time code and a resolution code,
wherein:
the plurality of pixel subsets comprises at least a low resolution subset resolution code and a remainder subset resolution code; and
a first half of the video data file comprises a greater number of pixel subsets associated with the low resolution subset resolution code than the remainder subset resolution code.

17. The video data file of claim 16, wherein the plurality of pixel subsets further comprises a medium resolution subset resolution code.

18. The video data file of claim 16, wherein all pixel subsets associated with the low resolution subset resolution code are contained within the first half of the video data file.

19. The video data file of claim 16, wherein each of the plurality of pixel subsets associated with the low resolution subset resolution code comprise substantially 10 percent of a complete video frame.

20. The video data file of claim 16, wherein each of the plurality of pixel subsets associated with the low resolution subset resolution code comprise pixels identified as representative of surrounding pixels in a complete video frame.
